(19) United States
(12) Patent Application Publication
(10) Pub. No.: US 2013/0129034 A1
(43) Pub. Date: May 23, 2013

(54) HYDROGEN VENTING DEVICE FOR COOLING WATER OF NUCLEAR REACTORS

(71) Applicants: A. Karel Velan, Westmount (CA); Vaclav Pauzer, Praha (CZ)

(72) Inventors: A. Karel Velan, Westmount (CA); Vaclav Pauzer, Praha (CZ)

(73) Assignee: VELAN INC., St-Laurent (CA)

(21) Appl. No.: 13/300,902

(22) Filed: Nov. 21, 2011

(51) Int. Cl. G21C 9/004; F16K 17/02

(52) U.S. Cl. 376/283; 137/197

(57) ABSTRACT

A hydrogen venting device for separating and releasing hydrogen gas from a gaseous mixture comprising hydrogen and steam generated in nuclear power plants is disclosed. The method includes providing a chamber at a high point in the cooling water circuit, allowing the collection chamber to cool below a gaseous mixture inlet temperature thereby allowing the hydrogen to collect at a first elevation within the collection chamber and condensate of the steam to collect at a second elevation within the collection chamber below the first elevation, and releasing substantially only hydrogen from the collection chamber at or proximal the first elevation when a threshold temperature, less than the first temperature, is reached.

### TECHNICAL FIELD

The present disclosure relates generally to a method, device and system for venting hydrogen from a primary cooling water circuit of a nuclear power plant.

### BACKGROUND

The recent catastrophic explosions at the Fukushima Daiichi plant in Japan were caused by hydrogen gas mixed with steam, that derived from the primary cooling water of the nuclear reactor. In the past, little consideration was given to the accumulation of hydrogen in nuclear power plants. In fact, some power plants have little or no provisions to deal with the problem of accumulated hydrogen in steam.

Nuclear reactors are made of corrosion resistant metal such as stainless steel or zirconium, and most are cooled by water in a closed circuit. The exposure of the hot water to intense radiation causes metallic corrosion, regardless of the metal used, thereby resulting in the formation of a metallic oxide and hydrogen gas. This hydrogen gas tends to cause embrittlement of the nuclear materials and induces excess pressure in the steam lines, and if not removed continuously from the system, can cause severe problems of explosion or potential meltdown.

The nuclear reactor cooling water circuit of most known pressurized water reactors (PWR) includes a reservoir in an elevated location, but still within the nuclear field, typically called a pressurizer. This vessel includes a gas space in the top of pressurizer (volume compensator) to protect the piping of the nuclear reactor from the thermal dilatation of the liquid. In existing nuclear power systems, it was assumed that the gas space in the pressurizer would fill only with steam at the corresponding steam temperature. However, hydrogen gas mixed with steam has been found to collect within the gas space of the pressurizer.

The heat capacity of a gas mixture of hydrogen and steam is vastly less than that of steam alone. In some nuclear stations, control valves are used to release the pressure from the pressurizer. In the case of overpressure in the nuclear reactor, a pressure relief tank (PRT) downstream thereof is pressurized. This pressure relief tank was thought to provide enough relief for an over-pressured cooling water circuit. However, the release by these control valves of a two-phase mixture containing both steam and hydrogen results in a build-up of dangerous hydrogen gas in the pressurized relief tank.

Therefore, most nuclear power plants either discharge the H₂/steam stream 34 continuously or periodically, with both methods having their own serious drawbacks. With a continuous discharge of H₂/steam stream typically using orifice plates, leads to overheating of PRT and causes system water levels to increase and may lead to blockage of orifices and eventual failure of hydrogen discharge. Periodically discharging the hydrogen/steam mixture drastically lowers the temperature within the system, thus upsetting the process conditions particularly in the connecting pipes where temperature is monitored in an attempt to maintain it at a constant value.

The current method commonly used to release hydrogen from the pressurized relief tank uses Hydrogen Extraction Membranes in the top of the pressure relief tank. These safety membranes are however effective only at extracting some hydrogen at pressures below 1500 psi. Most pressurized water reactors, however, have a cooling water circuit which operates at over 2000 psi, and the steam and hydrogen mixture which is released from the pressurizer into the pressure relief tank is typically in the range of about 2277 psi (157 bar) and 655 degrees Fahrenheit (346 degrees Celsius). Accordingly, the existing Hydrogen Extracting Membranes have been found to be insufficient to adequately release the hydrogen gas which may contain caesium, plutonium and iodine from the pressure relief tanks.

It is therefore desirable to find an improved way to safely release hydrogen gas from the cooling water circuit of a pressurized water nuclear reactor without releasing steam and other elements.

### SUMMARY

The presently described method, device and system provides for a virtually continuous automatic release of only gas, comprising mainly hydrogen, from the cooling water circuit of a pressurized water nuclear reactor. The present method and device which accomplish this thereby prevent the accumulation of compressed hydrogen in the piping circuit while releasing a minimum of steam therefrom, and virtually eliminating the two-phase discharge of steam, condensate and hydrogen into the pressure relief tank as was previously practiced.

In accordance with one aspect of the present invention, there is provided a hydrogen venting device for separating and releasing hydrogen from a steam/hydrogen mixture produced in a nuclear reactor system, the mixture having a saturated steam temperature, the device comprising: a body defining a cavity therein having an outlet disposed at a first elevation and an inlet disposed at a second elevation, the second elevation being below the first elevation; a stem having a sealing disk thereon which obstructs the outlet of the cavity, the stem being displaceable between a closed position wherein the sealing disk closes against a seat circumscribing the outlet and an open position wherein the sealing disk is spaced apart from the seat to allow a gas to vent through the outlet; and an actuator mounted within the cavity and operatively connected with the stem to displace the stem between said open and closed positions, the actuator comprising a thermostatic element configured to maintain the stem in the closed position when a temperature sensed by the thermostatic element within the cavity is at or above the saturated steam temperature and to displace the stem into the open position when the sensed temperature within the cavity drops to or below a hydrogen discharge temperature, the hydrogen discharge temperature being less than the saturated steam temperature and indicative of the presence of substantially only hydrogen within the cavity; wherein the hydrogen exits the cavity via said outlet when the stem is in said open position, and the hydrogen is substantially only hydrogen gas.

In accordance with another aspect of the device herein described, the thermostatic element comprises a bimetallic element with a plurality of at least four bimetallic segments.

In accordance with yet another aspect of the device herein described, the second temperature is between 250 and 290 degrees Celsius.

In accordance with still another aspect of the device herein described, the actuator is mounted on an actuator holder mounted within the outlet, wherein the holder defines an annular aperture through which the stem the exiting hydrogen passes.

In accordance with yet still another aspect of the device herein described, a strainer is provided within the body between the inlet and the outlet, the strainer collecting particulate matter, such as dirt and scale, thereby protecting the device by minimizing the likelihood of blockage of the device outlet and/or other damage caused by the dirt and scale.

In accordance with a further aspect of the device herein described, an outer surface of the body is substantially free of insulation such as to be exposed to atmospheric conditions surrounding the device.

In accordance with yet a further aspect of the device herein described, the device is in liquid communication with an oxidizer system converting the exiting hydrogen to water.

In accordance with still a further aspect of the present invention, there is provided a hydrogen venting system for separating and releasing hydrogen from a steam/hydrogen mixture generated in a nuclear reactor system, the mixture having a saturated steam temperature, the system comprising: a hydrogen venting device comprising a body defining a cavity therein having an outlet disposed at a first elevation and an inlet disposed at a second elevation below the first elevation; a stem having a sealing disk thereon which obstructs the outlet of the cavity, the stem being displaceable between a closed position wherein the sealing disk closes against a seat circumscribing the outlet and an open position wherein the sealing disk is spaced apart from the seat to allow a gas to vent through the outlet; and an actuator mounted within the cavity and operatively connected with the stem displacing the stem between said open and closed positions, the actuator comprising a thermostatic element operable to position the stem in the closed position when a temperature within the cavity is at or above the saturated steam temperature and to position the stem in the open position when a temperature within the cavity drops to or below a hydrogen discharge temperature less than the saturated steam temperature and indicative of the presence of substantially only hydrogen within the cavity; wherein the hydrogen exits the cavity via said outlet when the actuator displaces the stem into said open position, and the exiting hydrogen is substantially only hydrogen gas, and an oxidizer system fluidicly connected to the outlet of the device and receiving therein the hydrogen discharged from the device, the oxidizer system comprising a catalyst and an external oxygen source injected into the oxidizer system, the oxidizer system converting the discharged hydrogen to water through contact with the catalyst and a reaction with oxygen.

In accordance with yet still a further aspect of the system herein described, the oxidizer system comprises an oxidizer vessel comprising the catalyst therein, the vessel defining an inlet at the base of the vessel, an outlet opposite the inlet, a fluid recirculation loop transferring liquid/mixture in the oxidizer through the catalyst, wherein the device outlet is hydraulically connected to the bottom inlet and the oxygen source added at the base of the vessel through the fluid recirculation loop.

In accordance with one embodiment of the system herein described, the thermostatic element comprises a bimetallic element with a plurality of at least four bimetallic segments.

In accordance with another embodiment of the system herein described, the second temperature is between 250 and 290 degrees Celsius.

In accordance with yet another embodiment of the system herein described, the actuator is mounted on an actuator holder mounted within the outlet, wherein the holder defines an annular aperture through which the stem and the exiting hydrogen passes.

In accordance with still another embodiment of the system herein described, a strainer is provided within the body between the inlet and the outlet, the strainer collecting particulate matter.

In accordance with yet still another embodiment of the system herein described, an outer surface of the body is substantially free of insulation such as to be exposed to atmospheric conditions surrounding the device.

In accordance with yet a further aspect of the present invention, there is provided a hydrogen venting device for separating and releasing hydrogen from a steam/hydrogen mixture generated in a nuclear reactor system, the mixture having a first temperature and the hydrogen having a second temperature less than the first temperature, the device comprising: a body defining a cavity therein having an outlet disposed at a first elevation and an inlet disposed at a second elevation below the first elevation; a stem having a sealing disk thereon which obstructs the outlet of the cavity, the stem being displaceable between a closed position wherein the sealing disk closes against a seat circumscribing the outlet and an open position wherein the sealing disk is spaced apart from the seat to allow a gas to vent through the outlet; and an actuator mounted within the cavity and operatively connected with the stem displacing the stem between said open and closed positions, the actuator comprising a thermostatic element operable to position the stem in the closed position when a temperature within the cavity is above a threshold value and to position the stem in the open position when the temperature within the cavity is below the threshold value, wherein the threshold value is less than the first temperature of the steam and is greater than or equal to the second temperature of the hydrogen; wherein the hydrogen exits the cavity via said outlet when the actuator displaces the stem into said open position, and the exiting hydrogen is substantially only hydrogen gas.

In accordance with still a further embodiment of the present invention, there is provided a method of venting hydrogen from in a nuclear reactor system cooling water circuit producing a gaseous mixture comprising steam and hydrogen, the method comprising the steps of: providing a chamber at a high point in the cooling water circuit, the gaseous mixture collecting in the chamber at a saturated steam temperature; allowing the chamber to cool below the saturated steam temperature; separating the gaseous mixture within the chamber by allowing the hydrogen to collect at a first elevation within the chamber and condensate of the steam to collect at a second elevation below the first elevation; and releasing substantially only the hydrogen from the chamber at or proximal to the first elevation of the chamber when a second temperature, less than the saturated steam temperature, is reached.

In accordance with yet still a further embodiment of the method herein described, the releasing of substantially only the hydrogen is through a hydrogen venting device herein described, comprising the chamber.

In another aspect of the method herein described, the step of allowing the chamber to cool comprises passive cooling by exposing the chamber to atmospheric conditions.

In yet another aspect of the method herein described, releasing substantially only the hydrogen is by actuating a thermostatic element comprised within the device.

In still another aspect of the method herein described, the thermostatic element comprises a bimetallic element with a plurality of at least four bimetallic segments.

In yet still another aspect of the method herein described, further comprising an oxidation of the hydrogen to water in an oxidizer system.

### BRIEF DESCRIPTION OF THE DRAWINGS

FIG. 1 is a process flow-sheet of a nuclear power plant/system where the nuclear reactor is cooled with pressurized water in closed circuit including hydrogen venting devices in accordance with one embodiment of the present invention;

FIG. 2A is a schematic representation of a hydrogen venting device in accordance with one embodiment of the present invention, shown in a closed position accumulating a gaseous mixture of hydrogen and steam;

FIG. 2B is a schematic representation of the hydrogen venting device of FIG. 2a, shown with the accumulation of hydrogen in the top portion and condensate in the bottom portion of the device;

FIG. 2C is a schematic representation of hydrogen venting device of FIG. 2a, shown in an open position allowing accumulated hydrogen to escape;

FIG. 3A is a cross-sectional view of a hydrogen venting device in accordance with one embodiment of the present invention in an open position;

FIG. 3B is an enlarged cross-sectional view of the hydrogen venting device taken of region 3B-3B of FIG. 3A, showing detail of a seat and aperture in an open position;

FIG. 4A is a cross-sectional view of a hydrogen venting device in accordance with one embodiment of the present invention in a closed position; and

FIG. 4B is an enlarged cross-sectional view of the hydrogen venting device taken of region 4B-4B of FIG. 4A, showing detail of a seat and aperture in a closed position.

### DETAILED DESCRIPTION

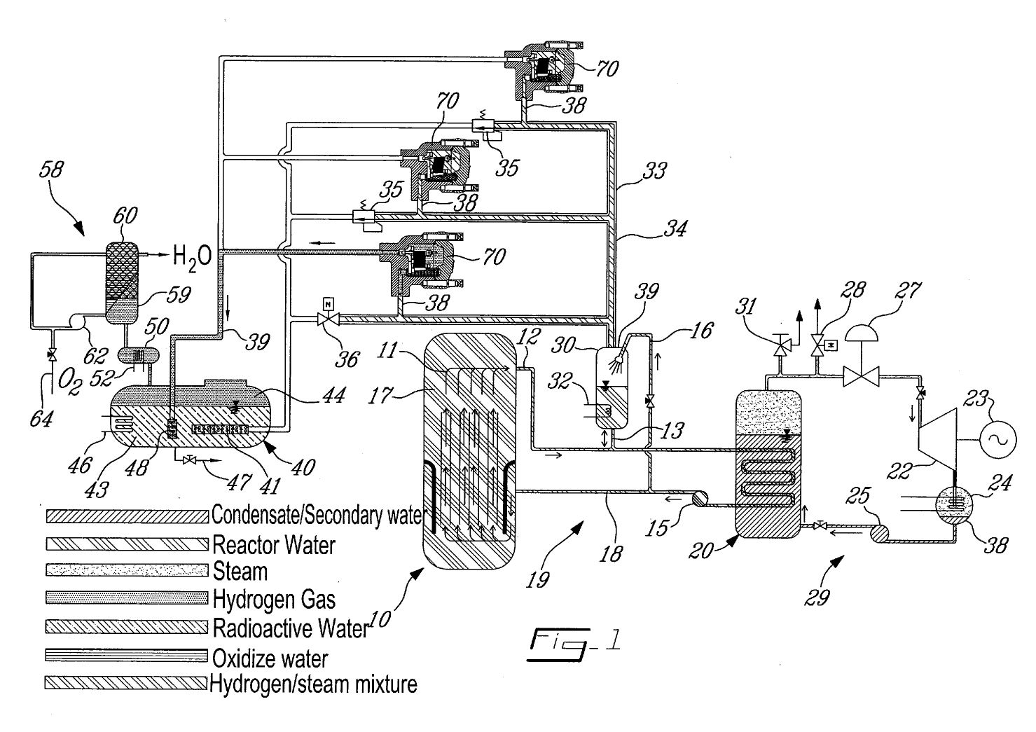

Referring to the nuclear power generating plant 1 shown in FIG. 1, the heart of the process for generating electricity is the nuclear reactor 10. A nuclear reaction within the reactor 10 is cooled by primary reactor water 11 within a Pressurized Water Reactor (PWR) 17 that recirculates through a closed cooling reactor water circuit 19. While this primary loop 11 does cool the PWR, one of its primary functions is as a heat exchanger to heat the water in the steam generator. The nuclear reactor cooling water circuit 19 comprises a water recirculating pump 15 that feeds cooler water into the PWR 17 through stream 18 located generally near the base of the reactor 10.

Within the PWR 17, reactor water 11 is recirculated through tubes in a generally upward direction. The nuclear reactor water 11 is thereby heated and leaves the reactor via stream 12 and enters a heat exchanger 14 within a steam generator 20. In the heat exchanger 14, the water gives up much of its energy, which is then used to produce electricity, and is returned to the PWR 17 by a water recirculating pump 15, via return nuclear water stream 18.

Electricity is generated using a steam/condensate closed circuit 29, starting from the steam generator 20 where water is vaporized to generate steam 21 with energy from the heat exchanger 14. This steam 21 leaves from the top of the steam generator 20, passes through a main steam isolation valve 27. The steam line leaving the steam generator 21 is generally protected from over pressure by pressure relief valves 31, and by electrically operated steam relief valve 28.

From the main steam isolation valve 27, steam 21 enters a steam turbine 22 that is coupled with an electrical generator 23 that produces electricity. The steam leaving the turbine 22 enters a condenser 24 where it is further cooled before returning to a condensate water recirculation pump 25. The condensed water 26 from pump 25 is then returned to the steam generator 20, and that generally through a control valve. This closed recirculating circuit 29 of steam and condensate produces the electricity without direct contact between the nuclear reactor cooling water circuit 19, and the steam/condensate cooling circuit 29.

The reactor water 11 of the PWR 17 becomes irradiated with radioactivity from the nuclear core within the reactor 10. As a byproduct of the high heat and radiation, the usually highly corrosion resistant zirconium or stainless steel reactor 17 vessel oxidizes. This oxidation of the vessel creates hydrogen in the reactor water loop 19 of the PWR 17 and then accumulates via connecting pipe 13, in an elevated tank 30, which is generally called the pressurizer 30.

Present best practices in nuclear power plants may not be completely acceptable. In some nuclear power plants the hydrogen gas is not discharged at all. However the presence of hydrogen within the system is dangerous for many reasons and must be removed safely. Since water is incompressible any changes in pressure or volume within the primary nuclear water circuit 19 are generally easily monitored in pressurizer 30 (in the absence of hydrogen). Therefore, a main function of the pressurizer 30 is to monitor and maintain proper pressure and volume with the PWR 17. The pressurizer 30 is designed to include a volume (or vapour space) 39 for the thermal dilatation of the water of the PWR 17, thus also protecting the circuit 19 from expansion and contraction of the circulating reactor water 11.

The pressurizer 30 is thus connected by the generally upwardly oriented connecting pipe 13, that helps to maintains constant pressure in the primary nuclear water circuit 19. The water and the steam in the pressurizer 30 are generally maintained at the point of saturation (e.g. 157 bar, 346° C.). The water in the PWR 17 and the primary cooling circuit 19 are kept below the saturation point to prevent boiling of the water (e.g. 157 bar, 319° C.). An electric heater 32 is provided within the pressurizer 30 to increase the temperature and pressure in the water and steam therein.

A cooling water injection line 16, generally from the outlet of the nuclear water recirculating pump 15, is also injected into the vapour space 39 of the pressurizer 30 when the pressure increases. To avoid sudden process changes in the pressurizer 30, the pressure column in the primary cooling water circuit 19 can thus be balanced by heating the liquid in the pressurizer 30 using the electric heater 32 and/or by injecting additional cooling water via the secondary cooling water flow from stream 16.

Therefore a gaseous mixture 34 comprising hydrogen and steam in the vapour space 39 of the pressurizer 30, leaves the pressurizer through exit piping 33. Since the hydrogen gas is lighter than steam, it fills the upper parts of the exit piping 33.

This exit piping 33 from the pressurizer 30 requires both automatically operated safety relief valves 35 and electrically operated safety relief valve 36 by law. The automatically operated safety relief valves 35 are generally designed to open upon an emergency increase in steam pressure in the system. The electrically operated safety relief valve 36 is generally designed and opened when a decision to close the nuclear station has been made. In an ideal system the pipe(s) 33 leading from the pressurizer 30 to the safety relief valves 35/36 are insulated to minimize heat loss. Heat loss causes condensation of the steam in the pipes, which keeps the pipes and valves preheated. Condensate from the hydrogen/steam mixture 34 flows back into pressurizer 30 and is replaced with new hydrogen/steam mixture 34 entering in the pipe(s) 33 from the pressurizer. Since hydrogen gas has a lower heat capacity than steam, the pipes tend to cool down and cause more steam to condense into water and flow back into pressurizer 30. This cycle will continue with more hydrogen accumulating and gradually filling the pipes and valves. This situation is unacceptable and potentially dangerous, because when safety relief valves 35/36 open they release the hydrogen gas and condensed steam mixture 34 into the PRT 40.

Therefore the system illustrated in FIG. 1, may release a mixture 34 of H₂/steam by opening automatic safety relief valve(s) 35 and/or electric safety relief valve 36 periodically. The injection of water (into pressurizer 30 via stream 16) causes the hydrogen and steam mixture 34 to separate and to enter the pipes 33 towards the safety relief valves 35/36. The mixture 34 released from valves 35 and/or 36 is sent via line 37 towards a pressure relief tank (PRT) 40 through distributor 41 immersed in water 43 in the PRT 40.

The difficulties described with regard to hydrogen/steam mixtures 34 are made worse under emergency conditions where larger volumes of steam and hydrogen are released into the pressure relief tank 40 that will almost certainly discharge hydrogen/steam and radioactivity into the plant with a subsequent hydrogen explosion.

The present inventors have found that by including hydrogen venting devices 70 on outlet stream 33 from pressurizer 30, many of the problems caused by the hydrogen/steam mixture from the pressurizer 30 can be overcome.

At least one hydrogen venting device 70 is provided in process line with the insulated pressurizer exit piping 33, upstream of the safety relief valves 35/36, and in a position and orientation such that the lighter hydrogen gas and the steam in the pressurizer exit piping 33 will tend to rise and fill the hydrogen venting device(s) 70. The device 70 and the pipe branch 38 extending from piping 33 are generally not insulated. Since the temperature of the hydrogen is lower by 21.1° C. to 38° C. than saturated steam temperature, a bi-metallic element within the device 70 will be actuated to allow the hydrogen to be discharged towards the PRT 40 for safe processing.

Therefore, the gaseous mixture 34 of hydrogen and steam accumulates in the hydrogen venting 70. As will be seen in further detail below, only the hydrogen will vent and/or otherwise escape from the hydrogen venting device 70, leaving behind the steam within the hydrogen venting device 70 and the upstream piping 33, while generally maintaining pressure and temperature within the system despite the hydrogen discharge. Although pressurizer exit piping 33 is illustrated as having three associated hydrogen venting devices 70 and controlled relief valves 35/36, it is to be understood that more or less than three such device 70 assemblies may be used on pipe(s) 33 of any given system.

The system illustrated in FIG. 1 shows three hydrogen venting devices 70, with one releasing hydrogen towards a pressure relief tank 40, while the other two devices are closed and not releasing hydrogen. The hydrogen from device 70 is released through line 37 and distributor 48, into the radioactive water in a Pressure Relief Tank (PRT) 40. The discharging hydrogen is at 250-290 degrees Celsius (482-554 degrees Fahrenheit), 20 to 40° C. (70-101 degrees Fahrenheit) below the saturated steam. As such this system provides optimum safety for the nuclear power plant by preventing any accumulation of hydrogen gas in the pressurizer 30 and the piping system upstream of the pressurizer 30. In the event that safety valves 35 or 36 open, no hydrogen gas will be discharged into the plant, thus eliminating the risk of explosion.

The PRT 40 system illustrated in FIG. 1 is equipped with a hydrogen dryer 50/hydrogen oxidizer system 58 that is used to eliminate hydrogen as steam and collects radioactivity. The hydrogen from the Pressure Relief Tank 40 enters a dryer 50 that removes the steam by condensing it within a cooler/condenser 52. From the dryer 50, the dried hydrogen enters an aqueous liquid recirculation loop through a bed of catalysts 60. Oxygen is added via an independent oxygen source 64. The circulation through the oxidizer filled with catalysts 60 is generally performed with a recirculation pump 62 where oxygen is fed upstream of the pump 62. Hydrogen is converted into water vapor that is released from the top of the oxidizer 60. The circulation loop is added to improve the reaction in the oxidizer 60.

The oxidizer system 58 includes a vessel 59 filled with catalysts that help oxygen and hydrogen (H₂) react to produce water (H₂O). The redox reaction proceeds in accordance with the following chemical equation:

H₂+O₂->2H₂O.

In many ways, this reaction is similar to that of a catalytic converter in a car that converts carbon monoxide to carbon dioxide by the reaction:

2CO+O₂→2CO₂.

The catalysts found in the oxidizer vessel 59 are generally small ceramic pellets or balls that are coated with a mixture of platinum and iridium or palladium. Aluminium oxide may also been used.

As the oxygen and hydrogen are mixed and recycled through the catalysts, the redox reaction occurs and the oxygen (O₂) and the hydrogen (H₂) combine to create water (H₂O) providing a safe method for disposing the discharged hydrogen from the system. The present system has the further advantage of releasing small amounts of hydrogen continuously to the oxidizer that can then operate on a continuous basis increasing the oxidizers conversion efficiency.

The hydrogen venting device(s) 70 of the present system is (are) schematically represented at a high point(s) in the pressurizer exit or vent line 33. The high point is a preferred location for the present hydrogen venting device 70 due to the low density of hydrogen gas, which thereby tends to accumulate at the highest point in a closed circuit. The hydrogen venting device 70 is understood to define a cavity therewithin that acts as a chamber where the gaseous mixture of hydrogen gas (H₂) and steam are collected and separated. The separation permits substantially only the hydrogen gas to be released from the device 70 while keeping the steam within the hydrogen venting device 70.

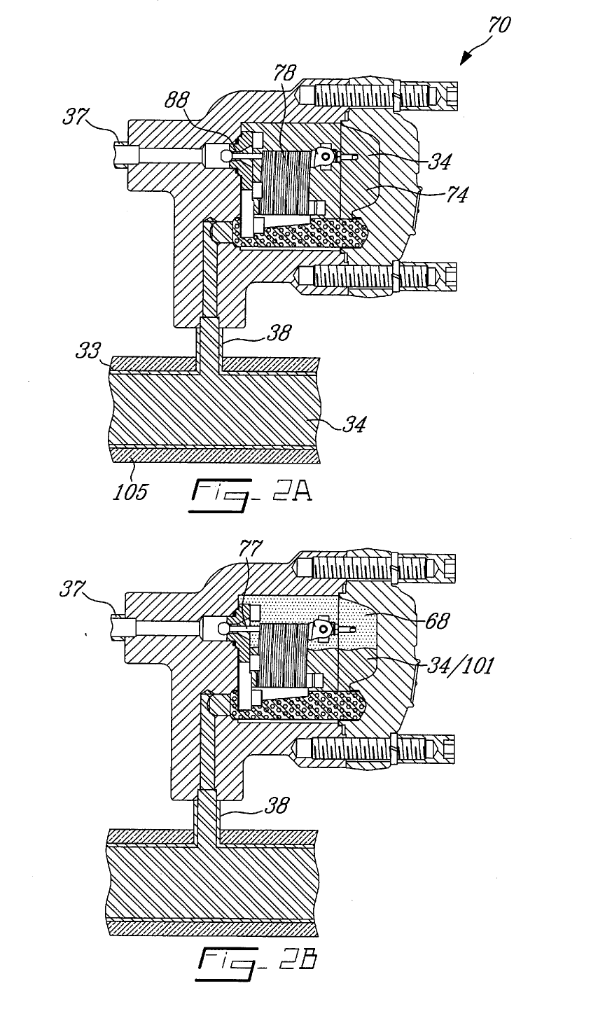

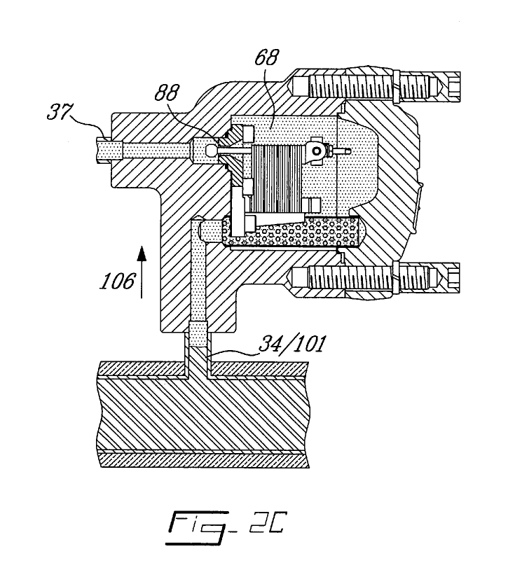

As will be described in further detail, the hydrogen venting device 70 shown in FIGS. 2A to 2C is configured to open at a predetermined or threshold temperature below the saturated steam temperature that allows substantially only hydrogen gas to vent out of the cooling water system thereby providing decompression while substantially maintaining system operating temperatures. The hydrogen venting device 70 of the present disclosure may, for example, be configured to open within a temperature range of 250-290 degrees Celsius (482-554 degrees Fahrenheit). This range is typically 20 to 40° C. below the saturated temperature of the H₂/steam mixture. The threshold temperature value is the cooler (lower) temperature achieved when substantially only hydrogen is in the chamber within the device 70.

As will be described in further detail with respect to its method of operation, the hydrogen venting device 70 is preferably not insulated, and similarly neither is the downstream hydrogen venting line 37 through which the hydrogen gas is bled from the system. In contrast, a majority of the pressurizer vent line 33 may be insulated. The short pipe branch line 38, immediately upstream of the hydrogen venting device 70, which fluidly interconnects the pressurizer vent line 33 and the hydrogen venting device 70 is also generally not insulated.

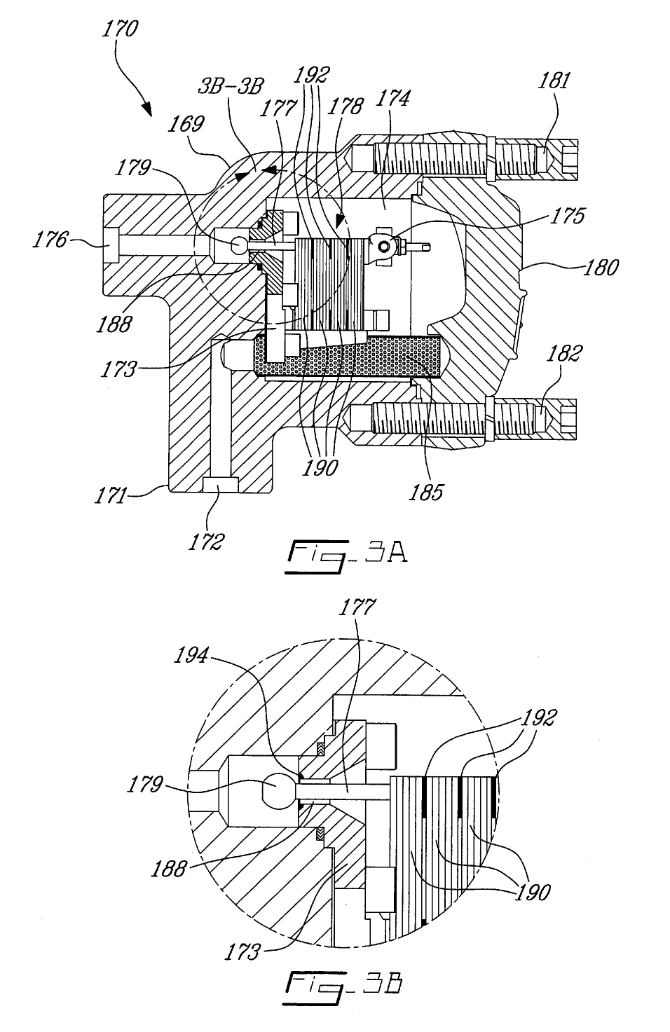

The method of the present disclosure will now be described through the schematic representation found in FIGS. 2A, 2B and 2C. A larger representation of the hydrogen venting device 170 described herein, is presented in FIG. 3.

Turning now to FIG. 2A that shows the hydrogen venting device 70 in cross-section, the pressurizer vent line 33 is covered with an insulating material 105 so as to minimize heat loses. The gaseous mixture 34 comprising hydrogen and steam is found within the pressurizer vent line 33 and the hydrogen venting device 70. The hydrogen venting device 70 is located above the line 33, i.e. at a higher elevation than the line 33, such that the lighter hydrogen gas is allowed to rise upwards into the body of the hydrogen venting device 70. FIG. 2A accordingly depicts the hydrogen venting device 70 having an opening exit, which is operatively connected to and actuated (i.e. opened and closed) by a temperature sensitive element (by-metallic strips) 78. The element 78 is shown in a bent/heated position that maintains the device outlet closed. The aperture 88 is in a closed position in FIG. 3A due to seated stem 77 and bent element 78, and is disposed near the top (i.e. higher elevation) of the device body in communication with the hydrogen venting device line 37.

The gaseous mixture 34 of steam and hydrogen at saturation is provided at a first temperature (i.e. 346° C.), and enters a collection chamber 74 defined within body of the device 70. The device 70 is generally not insulated, and therefore, fabricated of a metal adapted for use with steam and hydrogen, and is allowed to cool. This cooling can be passive by convection due to the cooler outside temperature of the device. Passive cooling is effective due to the high difference in temperature between the steam and the ambient air outside. However, the device 70 can also be cooled, in combination with a forced cooling mechanism, such as a cooling jacket.

As the hydrogen/steam mixture 34 enters the collector chamber within the device 70, it tends to separate into hydrogen and steam based on density, as hydrogen is substantially lighter than steam. The hydrogen 68 therefore rises to a first elevation near the top of the device. FIG. 2B, illustrates the beginning of the hydrogen 68/steam separation that will occur almost simultaneously with condensate 101 formation. The separated hydrogen is represented by the area at the top of the device and identified with the reference numeral 68. Simultaneously, condensate 101 is produced at a second elevation generally in the collector chamber, the second elevation being lower than the first elevation of the outlet aperture 88. The condensing steam will further cool the chamber within the device 70 to a lower temperature (e.g. 319° C.).

In FIGS. 2A to 2C, the temperature sensitive element 78 actuates a stem 77 that opens and closes the outer aperture 88 depending on the temperature within the device 70 body. FIG. 2C illustrates the collection chamber almost full of hydrogen 68, and a steam/H₂ 34 and condensate 101 mixture at the bottom of the device 70. The temperature sensitive bimetallic element 78 in a preferred embodiment is a thermostatic element that straightens and bends with varying temperatures, so as to open and close the device outlet aperture 88. For example, once the temperature of the fluid proximate the device drops below a predetermined differential temperature of the steam saturation point, which indicates that the fluid is substantially hydrogen gas 68 and not the high temperature steam/H₂ mixture, the stem 77 will open aperture 88 (as shown in FIG. 2C) to allow venting/release of substantially only hydrogen gas. As hydrogen is released, the chamber becomes filled with the higher temperature steam/H₂ mixture, thereby driving the temperature adjacent the device exit above a predetermined differential temperature of the steam saturation point, the temperature sensitive element bends to actuate the stem 77 will act to immediately close the aperture 88 (as shown in FIG. 2A) thus preventing the venting of any steam out of the device 70. In a particularly preferred embodiment the afore-mentioned thermostatic element includes one or more bimetallic elements. In a particularly preferred embodiment, four bimetallic elements are used in the device 70. The predetermined differential temperature for hydrogen discharge is typically 250 to 290° C., or 21 to 38° C. below the saturation temperature of steam in the system. The device 70 can be adapted to operate at different threshold temperatures.

In FIG. 2C, the escaping gas comprises only substantially hydrogen gas. It is to be understood that the substantially hydrogen stream is a vast majority mainly hydrogen but includes a small amount of steam dissolved therein. This mainly hydrogen gas is released from a position at, or proximal to, the first elevation of the chamber where the hydrogen accumulates and is well above the lower second elevation where the condensate is found. When the second temperature condition is reached, the hydrogen venting device 70 is found in an open position allowing hydrogen to escape through vent line 37. Hydrogen thus escapes very quickly, condensate 101 flashes and steam/H₂ 34 refills the collection chamber in an upward direction 106, thereby rapidly heating (and bending) the segments of the-temperature sensitive element within the chamber to the first higher temperature again and returning the stem 77 within the outlet aperture to a closed position illustrated in FIG. 2A.

FIGS. 2A to 2C are illustrative only, and it is to be understood that different forms of temperature sensitive elements and temperature actuated mechanisms can be envisaged for hydrogen venting. However, the present device releases substantially only H₂ gas, and not liquid condensate, and is adapted for very high pressure corrosive service including hydrogen. Furthermore, the orientation of the inlet of the hydrogen venting device for the gaseous mixture at a lower elevation and the outlet for hydrogen at a higher relative elevation in the device are specific for hydrogen.

FIG. 3A illustrates an example of the present invention according to one embodiment shown in cross section and in open position that permits the flow of hydrogen out of the device 170. The hydrogen venting device 170 comprises a hydrogen venting body 169 that has a base 171 defining an inlet 172 for the gaseous mixture (hydrogen/steam 34). The device 170 defines an internal collection chamber or cavity 174, in which there is mounted a bimetallic holder 173. The holder 173 supports a bimetallic actuator element 178.

The bimetallic element 178 includes a plurality of bimetallic segments 190. In a particularly preferred embodiment there are four bimetallic segments 190. The segments 190 are made up of multiple bimetal layers. A bimetal is a composite metal comprising two or more layers with different coefficients of expansion, which changes curvature when heated. A preferred type of bimetal has a high tensile strength and is stable at high temperatures with a deflection limited to approximately 315° C. that prevents overstressing at higher temperature and in super heated steam service. Therefore the bimetallic segments 190 each act independently and consecutively, developing forces in close relation to the saturated steam curve of the system. This permits sensitive efficient operation over a wide range of pressures. Thus the bimetallic segments 190 bend/straighten and generate enough force to actuate the stem 177 and consequently open (when the segments are straight) and close (when the segments are bent) the aperture 188. In preferred embodiment each bimetal segment 190 is separated from another segment by spacers 192 and there are typically two spacers 192 (one upper and one lower) between each bimetal segment 190.

The bimetallic element 178 is held by a bimetallic connector 175 joining it to a stem 177, that acts to open and close an aperture 188 located at the top of the device body 170. As can be seen clearly in enlarged FIG. 81, in a preferred embodiment the holder 173, is mounted within the device outlet 176, and defines the annular aperture 188 where the stem 177 is located and through which hydrogen gas flows through to the outlet 176.

The sealing disk 179 is in a preferred embodiment a spherical element mounted on the end of the stem 177 opposite the bimetallic element 178. Therefore the disk 179 may be in any number of shapes. The holder 173 includes a seat 194 on which the disk 179 seals the aperture 188. In a preferred embodiment the seat 194 is made of highly wear resistant material, such as a hardened steel and in a particularly preferred embodiment is made of Stellite® hardfaced.

In a preferred embodiment the device 170 may comprise a condensate strainer 185 in the bottom of the chamber 174, in connected to and proximal with the inlet 172. The strainer 185 acts to collect condensate and particulate matter such as dirt and scale and may also help distribute the incoming steam/hydrogen mixture within the cavity of the device. For maintenance purposes the device 170 furthermore includes a cover 180 that is bolted with studs and cap nuts, 181 and 182.

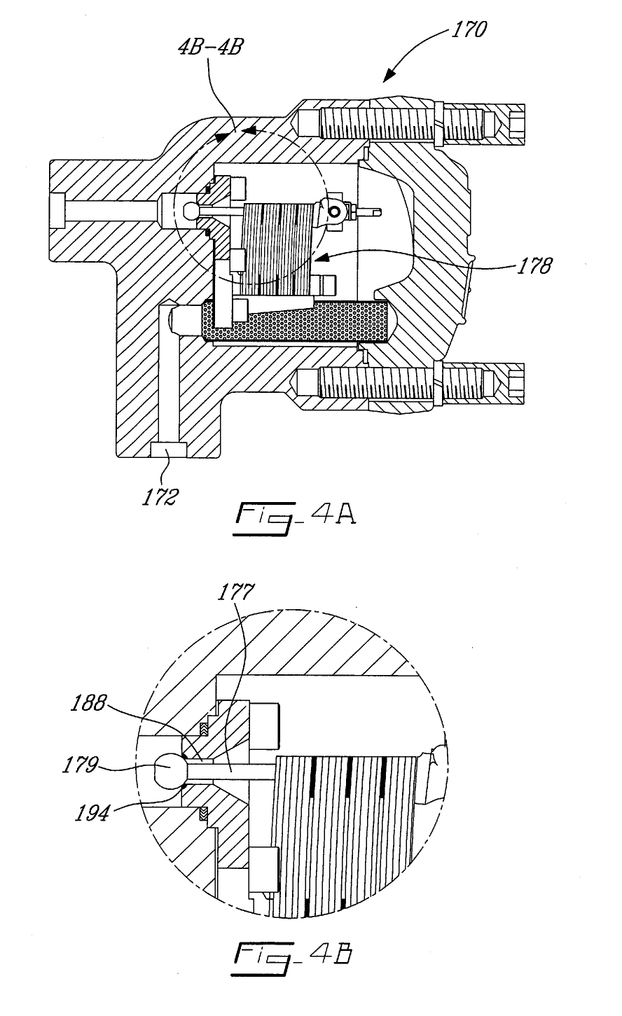

FIG. 4A illustrates the device 170 in greater detail in a closed position that retains the steam and hydrogen mixtures. FIG. 4B is an enlarged view of the device 170 in cross-section that more clearly illustrates the sealing disk 179 in contact with the annular seat 194 closing the aperture 188.

The device 170 works in the way previously described. A gaseous mixture enters the inlet 172 and fills the chamber 174 heating the bimetallic actuator element 178 therein and closing the aperture 188. The bimetal thermal pull increases with temperature thus shutting the disk 179 on the seat 194 of the aperture 188 and thus stopping the flow from the outlet 176.

As the device 170 is allowed to cool passively, hydrogen accumulates at the top of the chamber 174. This separation of hydrogen from the steam produces a reduction in temperature of the device body 170 and permits condensate to be formed at the bottom of the device. This process of hydrogen accumulation/steam condensation further cools the device. The drop in temperature within the chamber 174 causes the bimetallic actuator element 178 to relax. In relaxing the bimetallic element 178, straightens and moves the stem 177 towards an open position illustrated in FIG. 3A. When the device reaches a specific temperature the bimetallic actuator element 178 will be virtually straight and allow complete opening of the aperture 188.

The stem 177 in a preferred embodiment comprises a sealing body in the form of a ball or disc 179 located at the end of the stem 177, opposite from the bimetallic connector 175 and bimetallic actuator element 178.

When the device is open as seen in FIG. 3A, the hydrogen gas rapidly escapes from the outlet 176 because the chamber 174 is a relatively small volume. The chamber will the fill once again with a gaseous mixture of hydrogen and steam and from flashing condensate in the bottom of the device. The temperature with the chamber increases rapidly, the bimetallic actuator element 178 thermal pull increases to bend back to a closed position, illustrated in FIGS. 4A and 4B. Although the device 170 is presently cooled only with air, more active means may also be considered such as jacketing with a circulating fluid to cool the outside of the device. The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A hydrogen venting device for separating and releasing hydrogen from a steam/hydrogen mixture produced in a nuclear reactor system, the mixture having a saturated steam temperature, the device comprising:
a body defining a cavity therein having an outlet disposed at a first elevation and an inlet disposed at a second elevation, the second elevation being below the first elevation;
a stem having a sealing disk thereon which obstructs the outlet of the cavity, the stem being displaceable between a closed position wherein the sealing disk closes against a seat circumscribing the outlet and an open position wherein the sealing disk is spaced apart from the seat to allow a gas to vent through the outlet; and an actuator mounted within the cavity and operatively connected with the stem to displace the stem between said open and closed positions, the actuator comprising a thermostatic element configured to maintain the stem in the closed position when a temperature sensed by the thermostatic element within the cavity is at or above the saturated steam temperature and to displace the stem into the open position when the sensed temperature within the cavity drops to or below a hydrogen discharge temperature, the hydrogen discharge temperature being less than the saturated steam temperature and indicative of the presence of substantially only hydrogen within the cavity;
wherein the hydrogen exits the cavity via said outlet when the stem is in said open position, and the hydrogen is substantially only hydrogen gas.

2. The device according to claim 1, wherein the thermostatic element comprises a bimetallic element with at least four bimetallic segments.

3. The device according to claim 1, wherein the hydrogen discharge temperature is between 250 and 290 degrees Celsius.

4. The device according to claim 1, wherein the actuator is mounted on an actuator holder disposed within the cavity, the holder defining an annular aperture through which the stem the exiting hydrogen passes.

5. The device according to claim 1, wherein a strainer is provided within the cavity between the inlet and the outlet.

6. The device according to claim 1, wherein an outer surface of the body is substantially free of insulation so as to be exposed to atmospheric conditions surrounding the device.

7. The device according to claim 1, wherein the device is in fluid flow communication with an oxidizer system disposed downstream from the outlet, the oxidizer converting the discharged hydrogen to water.

8. A hydrogen venting system for separating and releasing hydrogen from a steam/hydrogen mixture generated in a nuclear reactor system, the mixture having a saturated steam temperature, the system comprising:
a hydrogen venting device comprising
a body defining a cavity therein having an outlet disposed at a first elevation and an inlet disposed at a second elevation below the first elevation;
a stem having a sealing disk thereon which obstructs the outlet of the cavity, the stem being displaceable between a closed position wherein the sealing disk closes against a seat circumscribing the outlet and an open position wherein the sealing disk is spaced apart from the seat to allow a gas to vent through the outlet; and
an actuator mounted within the cavity and operatively connected with the stem displacing the stem between said open and closed positions, the actuator comprising a thermostatic element operable to position the stem in the closed position when a temperature within the cavity is at or above the saturated steam temperature and to position the stem in the open position when a temperature within the cavity drops to or below a hydrogen discharge temperature less than the saturated steam temperature and indicative of the presence of substantially only hydrogen within the cavity;
wherein the hydrogen exits the cavity via said outlet when the actuator displaces the stem into said open position, and the exiting hydrogen is substantially only hydrogen gas, and
an oxidizer system connected to the outlet of the device and receiving therein the hydrogen discharged from the device, the oxidizer system comprising a catalyst and an external oxygen source injected into the oxidizer system, the oxidizer system converting the discharged hydrogen to water through contact with the catalyst and a reaction with oxygen.

9. The system of claim 8, wherein the oxidizer system comprises
an oxidizer vessel comprising the catalyst therein,
the vessel defining an inlet at the base of the vessel, an outlet opposite the inlet, a fluid recirculation loop transferring liquid in the oxidizer through the catalyst,
wherein the device outlet is hydraulically connected to the bottom inlet and the oxygen source added at the base of the vessel through the fluid recirculation loop.

10. The system of claim 8, wherein the thermostatic element comprises a bimetallic element with at least four bimetallic segments.

11. The system of claim 8, wherein the hydrogen discharge is between 250 and 290 degrees Celsius.

12. The system of claim 8, wherein the actuator is mounted on an actuator holder disposed within the cavity, wherein the holder defines an annular aperture through which the stem and the discharged hydrogen passes.

13. The system of claim 8, wherein a strainer is provided within the body between the inlet and the outlet, the strainer collecting particulate matter.

14. The system of claim 8, wherein an outer surface of the body is substantially free of insulation such as to be exposed to atmospheric conditions surrounding the device.

15. A hydrogen venting device for separating and releasing hydrogen from a steam/hydrogen mixture generated in a nuclear reactor system, the mixture having a first temperature and the hydrogen having a second temperature less than the first temperature, the device comprising:
a body defining a cavity therein having an outlet disposed at a first elevation and an inlet disposed at a second elevation below the first elevation;
a stem having a sealing disk thereon which obstructs the outlet of the cavity, the stem being displaceable between a closed position wherein the sealing disk closes against a seat circumscribing the outlet and an open position wherein the sealing disk is spaced apart from the seat to allow a gas to vent through the outlet; and
an actuator mounted within the cavity and operatively connected with the stem displacing the stem between said open and closed positions, the actuator comprising a thermostatic element operable to position the stem in the closed position when a temperature within the cavity is above a threshold value and to position the stem in the open position when the temperature within the cavity is below the threshold value, wherein the threshold value is less than the first temperature of the steam and is greater than or equal to the second temperature of the hydrogen;
wherein the hydrogen exits the cavity via said outlet when the actuator displaces the stem into said open position, and the exiting hydrogen is substantially only hydrogen gas.
